(19) United States
(12) Patent Application Publication
(10) Pub. No.: US 2016/0071646 A1
(43) Pub. Date: Mar. 10, 2016

(54) Thermally Stable High Performance Dielectrics

(71) Applicants: David P. Cann, Corvallis, OR (US); Natthaphon Raengthon, Bangkok (TH); Nitish Kumar, Corvallis, OR (US); Sandia Corporation, Albuquerque, NM (US)

(72) Inventors: Geoffrey L. Brennecka, Morrison, CO (US); Harlan James Brown-Shaklee, Albuquerque, NM (US); David P. Cann, Corvallis, OR (US); Natthaphon Raengthon, Bangkok (TH); Nitish Kumar, Corvallis, OR (US)

(21) Appl. No.: 14/840,804

(22) Filed: Aug. 31, 2015

Related U.S. Application Data
(60) Provisional application No. 62/048,119, filed on Sep. 9, 2014.

(51) Int. Cl. H01G 2/14; C04B 35/468; H01G 4/12

(52) U.S. Cl. CPC H01G 2/14; H01G 4/1227; C04B 35/4682

(57) ABSTRACT

Multilayer ceramic capacitors based on Bi(Zn,Ti)O₃—BaTiO₃ dielectrics can be integrated with wide band gap power electronics. The large permittivity values can be stable with both voltage and temperature; combined with the low equivalent series resistance typical of ceramic capacitors, these characteristics make the materials extremely attractive for high operating temperature inverter applications. In addition, the high resistivity values and large activation energies provide reliability over a long capacitor lifetime.

### CROSS-REFERENCE TO RELATED APPLICATION

This application claims the benefit of U.S. Provisional Application No. 62/048,119, filed Sep. 9, 2014, which is incorporated herein by reference.

### STATEMENT OF GOVERNMENT INTEREST

This invention was made with Government support under contract no. DE-AC04-94AL85000 awarded by the U. S. Department of Energy to Sandia Corporation. The Government has certain rights in the invention.

### FIELD OF THE INVENTION

The present invention relates to capacitor materials and, in particular, to thermally stable high performance dielectrics that can be used in ceramic capacitors for applications such as, but not limited to, power electronics that require operating temperatures above 200° C.

### BACKGROUND OF THE INVENTION

A number of existing and emerging applications, including next-generation power electronics modules based on gallium nitride (GaN) or silicon carbide (SiC), electronics for down-hole operations in the petroleum and natural gas (and related) industries, and a variety of applications in the military and aerospace industries, demand reliable capacitors that can operate at elevated temperatures with high power handling capabilities. Currently available options are to use expensive and bulky low permittivity ceramic capacitors that are rated for high temperature operation or to use much less expensive X7R or electrolytic capacitors well above their rated use temperatures. This latter option, while quite popular, requires active cooling and/or massive de-rating in order to achieve the desired system performance; this significantly increases complexity, volume, and cost and introduces reliability concerns. For example, in many present-day power inverter modules used to convert direct current (DC) to alternating current (AC), the active cooling system required by the Si-based electronics takes up roughly half of the entire system volume and commonly accounts for a large majority of the maintenance expense. Of the remaining system, it is common for nearly half of the volume to be occupied by capacitors.

FIG. 1 shows a generic inverter circuit for grid-tied energy storage module that uses a DC link capacitor C_{dcLink}. The circuit can convert DC current from an energy storage device to three-phase AC current for an electrical grid. Also shown are plots of the simulated voltage and current associated with the DC link capacitor in this circuit. In this example, the capacitor experiences a 1000 V bias baseline with >300 A transient currents on microsecond or faster time scales. Next-generation power electronics based on SiC and GaN will need to operate at ambient temperatures >200° C.; because of self-heating and power dissipation from other components, having capacitors rated for operation up to at least 300° C. is desired. Similarly, ambient conditions in down-hole applications and local temperatures in many transportation-related electronics applications have similarly temperature and power handling requirements.

Equivalent series resistance (ESR) is a critical parameter for high power capacitors because it represents the resistance to charge flow during each charging and discharging cycle. A large ESR leads not only to self-heating because of the resistive dissipation of power, but it also increases the RC time constant of the capacitor, increasing the amount of time required to reach a given state of charge. To compensate for the large ESR values inherent to electrolytic capacitors, modules are often designed with much larger capacitance values than would actually be required for baseline performance. The converse of this, of course, is that reducing the ESR of the capacitors used in a design can actually reduce the total capacitance requirements while increasing the operating frequency and power handling capability. Further, reduced ESR translates into greater efficiency because of reduced resistive losses.

Though there are some notable exceptions, the vast majority of electrolytic and polymer film capacitors have a very difficult time operating continuously at 125° C. ambient (many are rated to only 85° C., and even then with power restrictions). Since they are able to operate at higher temperatures in the first place and dissipate significantly less heat because of their lower ESR values, ceramic capacitors offer a lot of potential advantages for high power applications. However, use of ceramic capacitors in power electronics modules today is relatively rare. The reasons for this boil down to volume, reliability, and cost.

Therefore, a need remains for a high performance ceramic capacitor that can be used as an elevated operating temperature inverter for power electronics applications, as well as other applications that require thermally stable, high performance dielectric.

### SUMMARY OF THE INVENTION

The invention is directed to a dielectric comprising a (Ba,Bi)(Zn,Ti)O₃ perovskite ceramic comprising between 5 and 40 mol % Bi(Zn,Ti)O₃ and BaTiO₃. For example, the perovskite ceramic can comprise Bi(Zn_{0.5}Ti_{0.5})O₃-BaTiO₃. The dielectric can be further alloyed with SrTiO₃, NaNbO₃, BiScO₃, and/or BiAlO₃. The invention is further directed to a ceramic capacitor comprising at least two electric conductors separated by a dielectric comprising a (Ba,Bi)(Zn,Ti)O₃ perovskite ceramic. The ceramic capacitor can be a multilayer ceramic capacitor comprising alternating layers of (Ba,Bi)(Zn,Ti)O₃ perovskite ceramic sandwiched between metal electrode layers.

### BRIEF DESCRIPTION OF THE DRAWINGS

The detailed description will refer to the following drawings, wherein like elements are referred to by like numbers.

FIG. 1 is a schematic diagram of a DC link capacitor in a grid-tied energy storage module and simulation results of the voltage and current associated with the capacitor in such a setup.

FIG. 2 is a photograph of a group of capacitors capable of 400 nF at 2000V operation.

FIG. 3 is a graph of the electric field dependence of relative permittivity for BZT-BT ceramics compared to some other representative dielectric ceramics.

FIG. 4 is a graph of the energy density versus applied electric field for BZT-BT and other common ceramic dielectrics. FIG. 5 is a graph of the temperature dependence of relative permittivity for BaTiO₃ modified with appropriate Bi-based perovskite additions exhibiting relaxor dielectric behavior with remarkably stable temperature performance above T_{C}. The inset shows reductions in T_{C} with other perovskite additions.

FIG. 6 is a graph of electric resistivity and associated activation energies for conduction for BZT-BT and other common high permittivity ferroelectric-based ceramics.

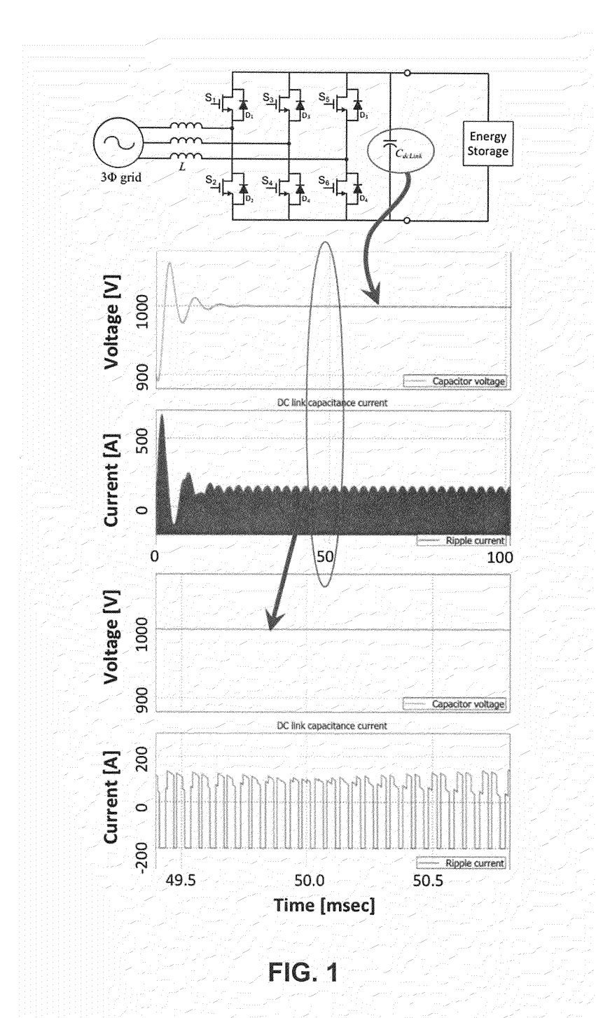

### DETAILED DESCRIPTION OF THE INVENTION

Specific atomistic mechanisms in certain ceramic dielectric materials can provide high dielectric permittivities that are inherently insensitive to electric fields and temperature. Such insensitivity is critical for energy storage applications because the energy stored per volume is dependent upon the high-field permittivity and the square of the applied electric field. The temperature dependence is critically important because many high-power applications require that these electrical properties remain stable at elevated operating temperatures. The following description focuses on capacitors used in power electronics for transportable storage. These modular systems are highly volume constrained because they must fit within a standard shipping container. Their needs for a combination of high operating temperatures, high power handling, small volume, and high reliability provide a challenging overall environment that serves as a sort of worst case scenario for component selection and integration, but improved capacitors will have an impact across a wide array of applications, anywhere that power needs to be stored, switched, or regulated under harsh conditions (in this case, high temperature, high electric field, and/or high power). Dielectric materials with these unique properties are of emerging interest for a number of energy-related applications such as power electronics, capacitors for electric transportation systems, grid-scale energy storage for alternative energy resources, energy storage systems for biomedical applications, and defense-related electric weapons systems.

According to the present invention, certain combinations of perovskite ceramics can exhibit a high dielectric permittivity that is relatively insensitive to temperature and electric field due to their unique chemical structure. The perovskite crystal structure is adopted by many oxides that have the formula ABO₃, where ‘A’ and ‘B’ are two cations of very different sizes, and the oxygen anion bonds to both. The ideal cubic-symmetry structure has the B-site cation in 6-fold coordination, surrounded by an octahedron of oxygen anions, and the A-site cation in 12-fold cuboctahedral coordination. The relative ion size requirements for stability of the cubic structure are quite stringent, so slight buckling and distortion, for example via doping, can produce several lower-symmetry distorted versions, in which the coordination numbers of the A cations, B cations, or both are reduced. In particular, a persistent highly polarizable material can be obtained by introducing chemically dissimilar cations on the A site and the B site. For example, the composition (Ba,Bi)(Zn,Ti)O₃ has dissimilar cations on the A site, namely Ba²⁺ which has a filled shell configuration, and Bi³⁺, which has a d¹⁰ electronic configuration as well as a lone pair electron. Furthermore, the B-site is configured with a filled shell cation Ti⁴⁺ along with a d¹⁰ cation Zn²⁺. This composition thus has cations with competing driving forces for crystallographic distortion. The Ba²⁺ ion prefers tetragonal distortions whereas the Bi³⁺ ion seeks rhombohedral distortions. Similar effects are seen on the B-site in this complex composition. In addition to this structural frustration at the atomic (or unit cell) level, the thermodynamics associated with mixing in these systems lead to chemical disorder and gradients at the mesoscopic level (within a single grain or crystal of the material but at the scale of many thousands of unit cells) during the thermal processing (i.e., sintering) steps of fabrication. It is this multi-level chemical and structural frustration on a local scale (i.e., tens of nanometers) and the resulting flat free energy landscape which results in the large permittivity values which are stable across a wide range of operating temperatures and applied electric field levels.

As described below, the engineered chemical disorder creates a complex random field, which has the following effects: (1) While the structure and composition of the material should favor the formation of long-range electric dipole interactions (i.e., a ferroelectric phase), the random fields inhibit these interactions and instead the material exists in a persistent highly polarizable state. (2) The chemical disorder results in a heterogeneous microstructure which aids in the dielectric properties. (3) The high temperature resistivity (and by extrapolation the dielectric breakdown) is also controlled directly by the random fields and associated large population of immobile deep trap sites which suppress the mobility of free electrons. (4) The high temperature stability can be directly controlled through the degree of atomic-level structural frustration (e.g., tolerance factor) and/or mesoscopic thermodynamically driven heterogeneity.

### Capacitor Fabrication

As an example of the invention, Bi(Zn_{0.5}Ti_{0.5})O₃—BaTiO₃ (BZT-BT) dielectrics were synthesized using conventional solid-state ceramic techniques from Bi₂O₃, ZnO, BaCO₃, and TiO₂ precursor powders. Solvent was removed by rotary evaporation to reduce particle segregation. Dried powders were lightly ground in a mortar and pestle, sieved, and calcined at 950° C. for 12 hours in air using a covered Al₂O₃ crucible. Single phase calcined powders were ball milled in ethanol to reduce particle size. Disc capacitors were produced by dry pressing BZT-BT powders containing 3 wt. % polyvinyl buturyl (PVB) binder at 35 MPa followed by isostatic pressing at 200 MPa.

Tape casting slurry containing nominally 60 vol. % BZT-BT dielectric powder was produced using a commercial binder system. Milled BZT-BT powders were dispersed in the PVB binder system by slow ball milling for 24 hours. Slurries were vacuum de-aired until no visible bubbles were released. De-aired slurry was then cast onto silicone coated mylar from a twin doctor blade on a heated bed. After drying, green tapes were cut and electrodes were applied by screen printing Pt co-fire ink. Printed dielectric tapes were collated to produce six active layers with buried electrodes and two support tape layers. Collated stacks were laminated and then singulated by CNC laser machining and hot knife dicing.

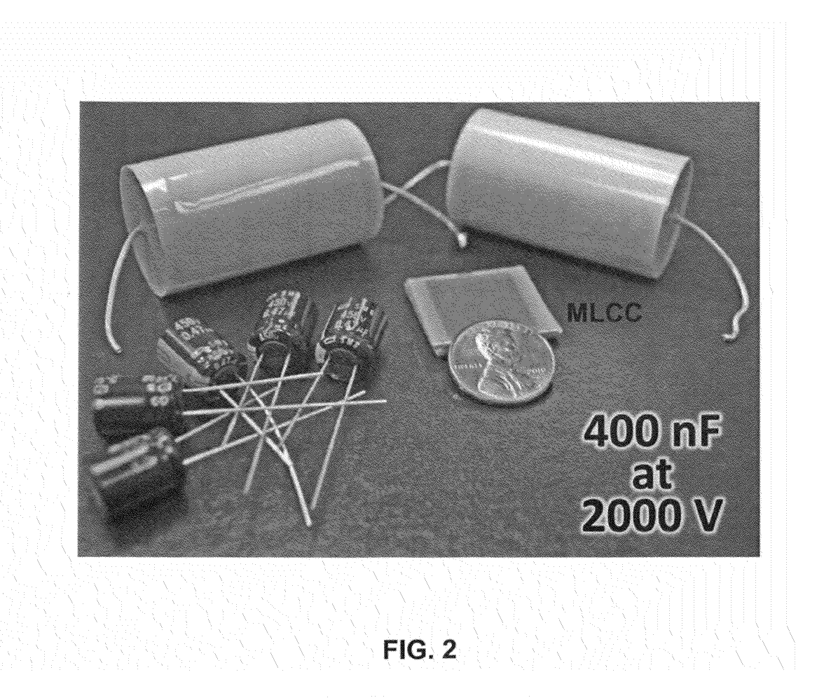

Multilayer ceramic capacitor (MLCC) stack binder removal was carried out in a tube furnace in a flowing O₂ atmosphere and was monitored by in situ residual gas analysis (RGA). In situ RGA was also used to monitor the gases evolved during sintering in an Al₂O₃ tube furnace. Analysis of RGA data was then used to optimize the binder removal and sintering profiles to prevent the formation of blister defects associated with entrapped gases. After sintering, the same Pt ink used for screen printing was applied by hand to capacitor ends to form active electrode terminations. The end result of this processing is shown in FIG. 2, which compares the MLCC with other capacitors with similar capacitance. Each layer of the MLCCs had active areas about the size of a U.S. penny and dielectric layer thicknesses of approximately 150 μm. Each MLCC had a capacitance of 200 nF and was designed for operation at 2000 V.

### Properties and Performance

The primary parameter of importance for capacitors is, not surprisingly, capacitance, but this is only one of many important properties to consider. Capacitance (for a simple parallel plate configuration which is appropriate for a planar MLCC) is related to the intrinsic materials properties by the equation

$$C = \frac{{KAɛ}_{0}}{t} \qquad ( 1 )$$

where C is capacitance (in Farads, or more commonly nF), K is relative permittivity (dielectric constant), A is active dielectric area, ε₀ is the permittivity of free space (8.854 E⁻¹² F/m), and t is the thickness of the dielectric (electrode separation distance). This equation highlights the importance of having large active areas and small thicknesses in order to achieve large capacitance values, but it hides the dependence of relative permittivity on applied electric field.

Supercapacitors and electrolytic capacitors both achieve extremely large areas and thin layers, but this increase brings with it large ESR values because of the often thin and tortuous electrodes. These kinds of capacitors also utilize dielectric materials that have low or moderate relative permittivity values (e.g., K_{Ta2O5}≈27), but importantly, these values are stable with applied electric field.

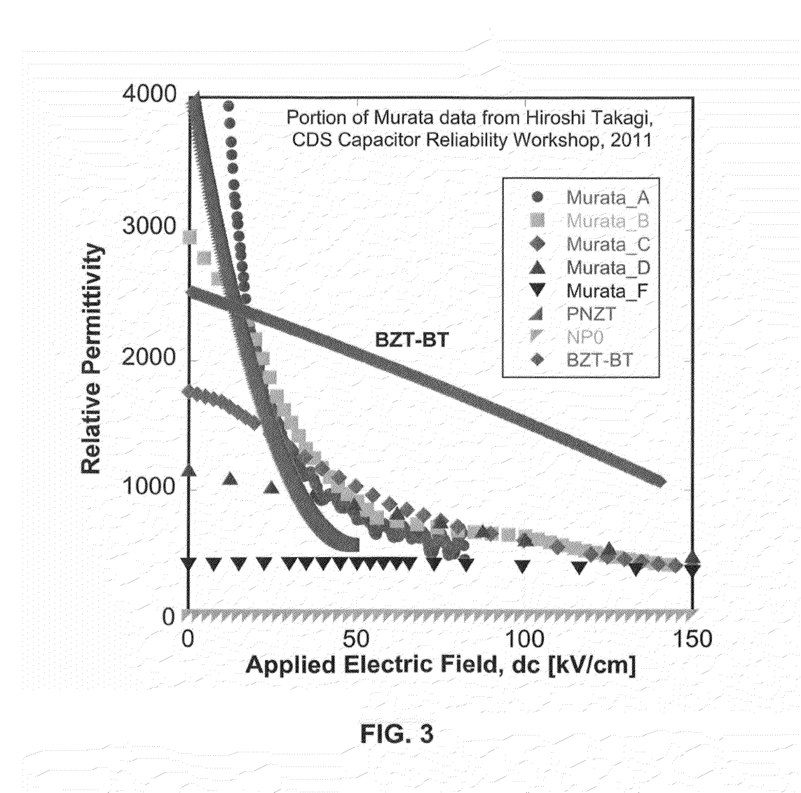

Most MLCCs based on ferroelectric materials, on the other hand, exhibit extremely large relative permittivity values (e.g., >3,000 for traditional BaTiO₃-based X7R dielectrics, >50,000 for some Pb-based relaxor dielectrics), but these large permittivity values are highly field-dependent, typically dropping below 300 under fields of ˜100 kV/cm, as shown in FIG. 3. This behavior is of minimal concern for applications that require high capacitance density at relatively low operating fields, but for a DC link capacitor and other high field applications, this behavior is highly undesirable.

### Energy Density

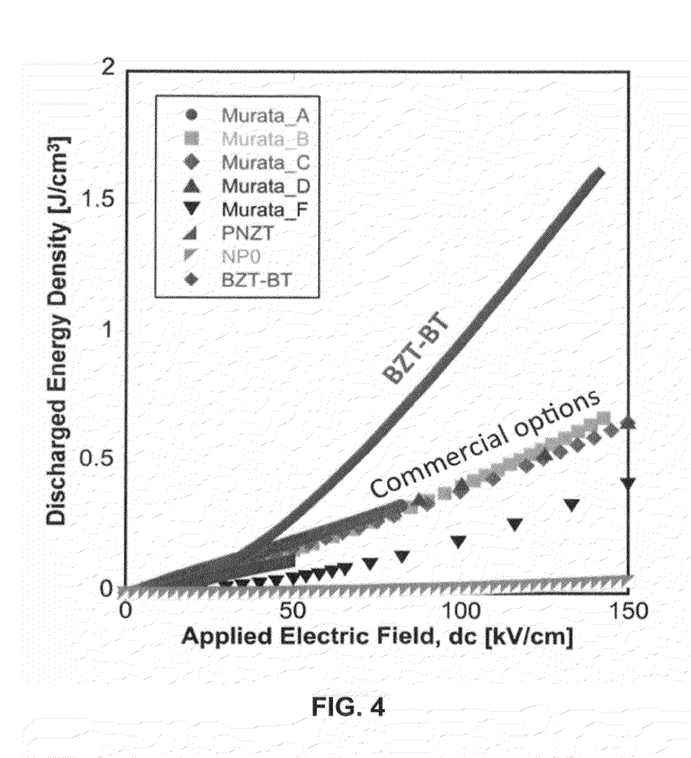

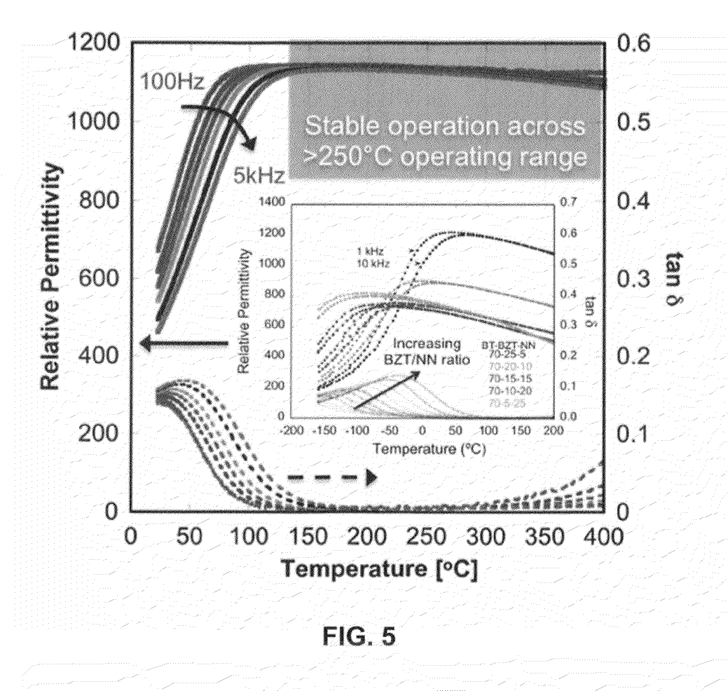

In some applications, DC link capacitors being one example, both capacitance density and energy density are of high importance. The energy stored in an electrostatic capacitor can be expressed as

$$J = {\int }_{0}^{0} V d q ⇒ \frac{1}{2} {CV}^{2} \qquad ( 2 )$$

where J refers to energy (typically in joules or scaled to volume as J/cm³), V is voltage, and C is capacitance which can have a voltage dependence; the simplification to J=0.5 CV² is only strictly valid for linear capacitors which show no field dependence. Translating this into intrinsic properties, stored energy varies directly with relative permittivity but with the square of the electric field; this means that maintaining a large permittivity under large electric fields is important for achieving large energy densities. From the data in FIG. 3 (after smoothing and knowing from other measurements that hysteretic losses in these materials are quite small), the energy density stored and available for discharge for each of these dielectrics can be plotted, as shown in FIG. 4. It is apparent that although the low-field permittivity of the BZT-BT material of the present invention is not as high as some of the other dielectrics, the fact that it maintains a large relative permittivity at high fields corresponds to much greater energy densities. Data from Murata capacitors has been used in these figures because they are representative of the current state of the art in ferroelectric-based MLCCs.

### High Temperature Operation

The present invention provides dielectrics and capacitors capable of operating reliably and with high energy and high capacitance densities at ambient temperatures in excess of 200° C. Pure BaTiO₃ undergoes a phase transition associated with its Curie temperature (T_{C}) near 125° C., and much of the success of the MLCC industry is a direct consequence of technologies that chemically shift and broaden this phase transition in a way that provides relatively stable low-field permittivity values across the temperature range between −55° C. and 125° C. Materials which offer stable dielectric response at higher temperatures are almost exclusively those with low relative permittivities. However, Bi(Zn_{0.5}Ti_{0.5})O₃ additions to BaTiO₃ flatten the permittivity response above T_{C} and result in a dispersive relaxor-like response below T_{C}. See C.-C. Huang and D. P. Cann, J. Appl. Phys. 104, 024117 (2008); N. Raengthon and D. P. Cann, IEEE Trans. Ultrasonics, Ferroelectrics, and Freq. Control, 978 (2010); N. Raengthon and D. P. Cann, J. Am. Ceram. Soc. 95, 1604 (2011); and D. H. Choi et al., J. Am. Ceram. Soc. 96, 2197 (2013). As shown in FIG. 5, additional doping of BiTiO₃—Bi(Zn,Ti)O₃ with BiScO₃ results in remarkable temperature stability of permittivity above T_{C} but retains the relaxor response near room temperature. See N. Raengton et al., J. Am. Ceram. Soc. 95, 3554 (2012). For applications which require operation to lower temperatures as well, SrTiO₃, NaNbO₃ and other additives can effectively shift T_{C} to temperatures well below 0° C. See N. Raengthon et al., J. Mater. Sci. 48, 031401 (2012). Therefore, the temperature range for stable operation can be shifted by about 250° C. via chemical modification without sacrificing voltage stability.

### Resistivity

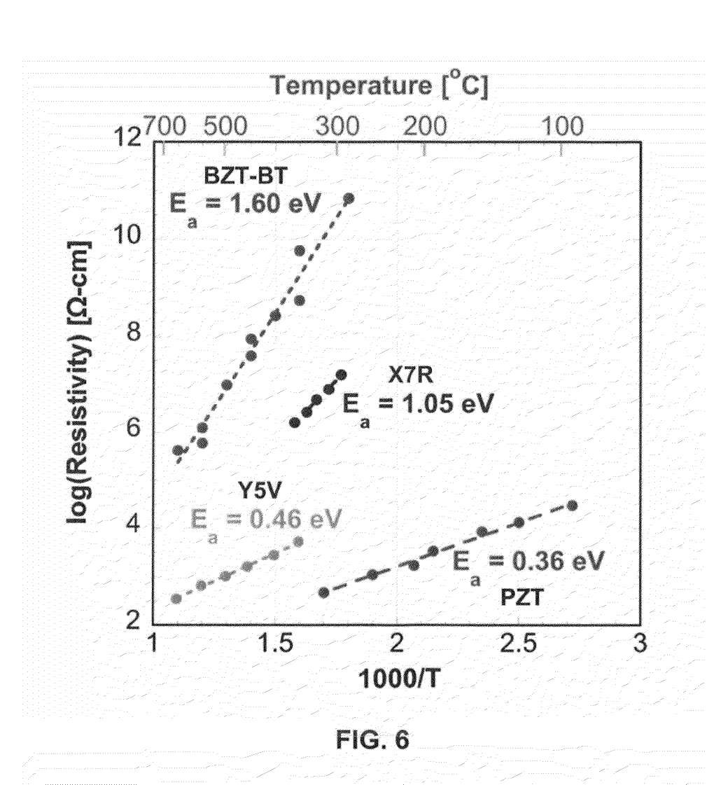

Capacitor failures have been shown to account for roughly half of the failures in photovoltaic inverter systems, so testing the degradation and failure mechanisms of these new dielectrics in order to get an indication of their reliability is a high priority. See J. D. Flicker et al., “PV Inverter Performance and Reliability: What is the Role of the Bus Capacitor?,” Proc. of the 38th IEEE Photovoltaic Specialists Conf., Austin, Tex., (2012). Long-term degradation is generally due to the migration of charged ionic defects. See C. A. Randall et al., J. Appl. Phys. 113, 014101 (2013). Electrical resistivity and associated activation energy measurements can provide a preliminary indicator of high operating temperature reliability. FIG. 6 shows the temperature dependent resistivity and corresponding activation energy values from measurements on BZT-BT dielectrics as well as comparisons to other typical dielectric ceramics. The significantly higher resistivity and much larger activation energy values both suggest that BZT-BT dielectrics are promising materials for higher reliability and longer life operation, particularly at elevated temperatures. See N. Raengthon et al., Appl. Phys. Lett. 101, 112904 (2012).

The present invention has been described as thermally stable high performance dielectrics. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A dielectric comprising a (Ba,Bi)(Zn,Ti)O₃ perovskite ceramic comprising between 5 and 40 mol % Bi(Zn,Ti)O₃ and BaTiO₃.

2. The dielectric of claim 1, wherein the Bi(Zn,Ti)O₃ comprises Bi(Zn_{0.5}Ti_{0.5})O₃.

3. The dielectric of claim 1, further comprising additions of SrTiO₃, NaNbO₃, BiScO₃, or BiAIO₃.

4. A ceramic capacitor comprising at least two electric conductors separated by a dielectric comprising a (Ba,Bi)(Zn,Ti)O₃ perovskite ceramic.

5. The ceramic capacitor of claim 4, wherein the ceramic capacitor comprises a multilayer ceramic capacitor comprising alternating layers of (Ba,Bi)(Zn,Ti)O₃ perovskite ceramic sandwiched between metal electrode layers.
